(19) United States
(12) Patent Application Publication
(10) Pub. No.: US 2011/0176872 A1
(43) Pub. Date: Jul. 21, 2011

(54) PROCESS FOR WETTING A WATER REPELLENT SOIL

(75) Inventor: Paul Thomas Bially, Mount Royal, NJ (US)

(73) Assignee: Lamberti USA, Inc., Conshohocken, PA (US)

(21) Appl. No.: 12/688,612

(22) Filed: Jan. 15, 2010

(51) Int. Cl. B09C 1/08

(52) U.S. Cl. 405/128.75

(57) ABSTRACT

Water repellent soils may be treated with an aqueous wetting composition comprising from 10 to 100,000 ppm of an anionic derivative of alkyl polyglycosides to improve the ability of the soil to be penetrated by water. This composition may also be combined with certain known wetting agents to produce a synergistic wetting effect. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. 37 CFR 1.72(b)

### FIELD OF THE DISCLOSURE

The present disclosure relates to a process for wetting soils, in particular, water repellent soils, comprising the use of aqueous compositions containing anionic surfactant derivatives of alkyl polyglycosides.

### BACKGROUND OF THE ART

Adequate root zone moisture is necessary in order to support the growth and development of most plant species. Root zone moisture is partly a function of the timing, duration, and uniformity of precipitation and irrigation applied to plants and soil. It is also dependent on the physical, chemical, and biological properties of the soil surface, which can directly affect the infiltration and retention of water and aqueous compositions within the soil profile.

Soil water repellence is a naturally occurring process affecting the performance of plant growth media. It is characterized by changes in the surface chemistry of soils that impede or completely inhibit hydration. Water repellent soils present agriculturalists with significant hydrologic and agronomic challenges such as: retarding water infiltration into the soil (leading to runoff, erosion, and leaching), and affecting the regular growth and maintenance of turf grass and a variety of agricultural crops.

Practical methods of classification of water repellence of soils exist, and one of the most commonly accepted is the Waterdrop Penetration Time method (or Water proplet Penetration Test, WDPT), as reported in “Water repellent soils: a state-of-the-art” (by Leonard F. Debano), in General Technical Report PSW-46, 1981. For the purposes of the present disclosure, soils are considered to be water repellent if the Waterdrop Penetration Time exceeds five seconds.

Nonionic surfactants are typically used to improve the wetting and water retention of water repellent soils due to their proven efficacy and phyto-safety. Ethylene oxide-Propylene oxide (EO/PO) block polymers have been researched extensively and are used widely in the golf course industry to maintain optimal turf grass health and improve water use efficiency. Recent studies have shown that EO/PO block copolymers with a higher molecular weight and lower HLB generally induce the fastest soil hydration, a desired attribute in end use application.

Alkyl polyglycosides (APGs) are viewed as an emerging class of surfactants with distinct environmental and performance benefits. They are readily biodegradable, have a low toxicity profile, and are derived from renewable resources. These sugar-based amphiphiles demonstrate strong aqueous solubility and tend to remain thermodynamically stable when blended with high concentrations of electrolytes.

We have now discovered that diluted aqueous formulations of anionic derivatives of alkyl polyglycosides act as highly efficient wetting compositions for water repellent soils.

### SUMMARY OF THE DISCLOSURE

In one aspect the present disclosure relates to a process for wetting a soil characterized by applying an aqueous wetting composition comprising from 10 to 100,000 ppm of an anionic derivative of alkyl polyglycosides to the soil.

In another aspect, the present disclosure relates to a process for wetting a soil comprising applying an aqueous wetting composition comprising: an anionic derivative of alkyl polyglycosides; and a compound which is known to function as a wetting agent, to the soil.

In still another aspect, the present disclosure relates to soil treated using a method characterized by applying an aqueous wetting composition comprising from 10 to 100,000 ppm of an anionic derivative of alkyl polyglycosides to the soil.

### DETAILED DESCRIPTION OF THE DISCLOSURE

It was found that anionic derivatives of alkyl polyglycosides exhibit shorter water infiltration times through the repellent test soil compared to ethylene oxide-propylene oxide (EO/PO) block polymers and to traditional nonionic alkyl polyglycosides, especially at low concentrations, i.e. at 4,000 ppm or lower.

The tests indicate that the anionic derivative of alkyl polyglycosides may be highly effective wetting agents for water repellent soils even if used at low concentration as the sole wetting agents.

Additionally, the anionic derivatives of alkyl polyglycosides are quickly biodegradable and satisfy the desire for low toxicity in mammals and a low irritating effect in contact with the epidermis. They are therefore particularly suited for preparations to be used on agricultural crops, turf grasses, seeds, and in the production of plant growth media. The mixtures of the present disclosure are free of harmful or toxic by-products, like amines, ethylene oxide, 1,4-dioxane, alkyl phenols, etc.

In one embodiment, the aqueous wetting composition includes from 400 to 4,000 ppm of anionic derivative of alkyl polyglycosides.

The useful anionic derivative of alkyl polyglycosides include, but are not limited to anionic carboxylic esters of alkyl polyglycosides, alkyl polyglycoside ether carboxylates, and alkyl polyglycosides phosphates, betaines, sulfates, sulfosuccinates and sulfonates, such as those described in U.S. Pat. Nos. 7,241,875; 7,384,904; 7,087,571; 6,627,612; and 6,958,315; all of which are fully incorporated herein by reference. Other references which may describe these compounds include: WO 2004/052901, EP 510564, EP 510565, and EP 258814. EP 510564, EP 510565, and EP 258814 especially may disclose such compounds and their method of production.

In one embodiment of the present disclosure, the anionic derivative of alkyl polyglycosides may be an anionic carboxylic ester of alkyl polyglycoside represented by the formula (I):

[R—O-(G)ₓ]ₙ-(D)_{y} (I)

wherein:
R may be an aliphatic group, saturated or unsaturated, linear or branched, having from 6 to 20, preferably from 8 to 16, atoms of carbon;
G may be a residue of a reducing saccharide, and preferably a glucose residue, connected to R—O by means of an ether O-glycosidical bond;
O may be an oxygen atom;
D may be an acyl residue of a polycarboxylic acid, preferably of a sulfosuccinic acid or of a carboxylic acid selected from the group consisting of citric acid, tartaric acid, maleic acid, malic acid, and mixtures thereof, in acid or salt form;
n may be a number between 1 and m−1, where m may be the number of carboxylic groups in the acid that originates D;
x may be a number from 1 to 10, representing the average degree of oligomerization of G; and
y may be a number from 1 to 10 representing the degree of average esterification of (G)ₓ.

In some embodiments, it may be desirable to employ compounds of formula (I) wherein D may be the acyl residue of sulfosuccinic, citric, or tartaric acid in their sodium salt form. According to a particularly desirable aspect, the effective aqueous wetting composition comprises very small amounts of anionic derivative of anionic alkyl polyglycoside, i.e. from 400 to 4,000 ppm of anionic derivative of alkyl polyglycosides.

Tests indicate that aqueous wetting compositions including from 400 to 4,000 ppm, more preferably from 400 to 2,000 ppm of an anionic derivative of alkyl polyglycosides, and about equal amounts of a compound that may be known to function as a wetting agent and may be selected among the group consisting of 4 to 20 moles ethoxylated, optionally propoxylated, C₈-C₂₂ fatty alcohol, dioctyl sulfosuccinate sodium salt and ethylene oxide/propylene oxide block copolymers with a mass average molecular weight from about 1,000 to about 3,000 show a synergistic wetting effect, which may be due to the combined presence of the two wetting agents.

The aqueous wetting composition may further contain anti-drift agents and anti-foams.

The following Examples serve to illustrate the efficacy of the aqueous wetting compositions according to the disclosure. Comparisons are made with analogous compositions prepared from known wetting agents, such as anionic alkyl polyglycosides and other surfactants. Also, the synergism of the combined use of the anionic derivatives of alkyl polyglycosides and other wetting agents is illustrated.

### EXAMPLES

### Method

A water repellent test soil was prepared in the laboratory by blending a hydrophilic greens mix sand with octadecyl trichlorosilane (OTS) prepared as set forth in the publication: Preferential Flow in Water-Repellent Sands Bauters et al, Soil Sci. Soc. Am. 1. 62:1185-1190 (1998). Product test solutions were evaluated using a standardized water droplet penetration test (WDPT). Droplets of water or aqueous surfactant solutions were placed on the surface of water repellent sand and the time required to infiltrate into the soil was measured in seconds. Wetting efficacy was inversely proportional to penetration time, i.e. compositions with shorter penetration times were generally considered more effective. Three replicates were run for each treatment and the average result was reported. Control composition (distilled water) gave wetting data>100,000.

### Products Tested.

EC: compound of formula (I) with R═C₁₂-C₁₄ linear alkyl, G=glucose residue, D acyl residue from citric acid sodium salt, x=1.2;

ET: compound of formula (I) with R═C₁₂-C₁₄ linear alkyl, G=glucose residue, D acyl residue from tartaric acid sodium salt, x=1.2;

SS: compound of formula (I) with R═C₁₂-C₁₄ linear alkyl, G=glucose residue, D acyl residue from sulfosuccinic acid sodium salt, x=1.2;

Monatrope 1620: C₈-C₁₀ nonionic alkyl polyglycoside from Croda;

AG 6210: linear C₈-C₁₀ nonionic alkyl polyglycoside from Akzo Nobel;

L61: EO/PO block copolymer from Rhodia

L62: EO/PO block copolymer from Rhodia

L64: EO/PO block copolymer from Rhodia

7EO/ISD: 7 moles ethoxylated isodecyl alcohol

### Results and Discussion

Table 1 reports the single components wetting data at various dosage.

TABLE 1
Wetting data

| | 2,000 | 1,000 |
|---|---|---|
| | ppm | ppm |
| EC | 52.6 | 222.6 |
| SS | 65.2 | 251.6 |
| ET | 61.4 | 265 |
| L61 | >600 | >600 |
| L62 | >600 | >600 |
| L64 | >600 | >600 |
| Monatrope 1620 | 38.6 | >600 |
| AG6210 | 72.6 | >600 |
| 7EO/ISD | 3 | >600 |

Table 2 reports the wetting data of blends of anionic derivatives of alkylpolyglycosides and EO/PO block copolymers, dosed at 2,000 ppm, in variable ratios (“3 to 1” means 3 parts by weight of anionic derivatives of alkylpolyglycosides and 1 part by weight of EO/PO block copolymer and 1 to 3 the vice versa)

TABLE 2
Wetting data

| | 3 to 1 | 1 to 1 | 1 to 3 |
|---|---|---|---|
| EC + L64 | 71.8 | 37.2 | 330 |
| SS + L64 | 140 | 57.8 | 480 |
| ET + L64 | 51.8 | 41.6 | 128 |

Table 3 reports the wetting data of blends of anionic derivatives of alkyl polyglycosides, at low dosage.

TABLE 3
Wetting data

| | |
|---|---|
| SS (450 ppm) + L61 (1,000 ppm) | 17.00 |
| SS (450 ppm) + L62 (1,000 ppm) | 152.66 |
| SS (500 ppm + 7EO/ISD (500 ppm) | 108.6 |

What is claimed is:

1. A process for wetting a soil comprising applying an aqueous wetting composition comprising from 10 to 100,000 ppm of an anionic derivative of alkyl polyglycosides to the soil.

2. The process of claim 1, wherein the aqueous wetting composition comprises from 400 to 4,000 ppm of the anionic derivative of alkyl polyglycosides.

3. The process of claim 1 wherein the aqueous wetting composition additionally comprises from 90 to 97.97% water.

4. The process of claim 1 wherein the aqueous wetting composition additionally comprises a component selected from the group consisting of anti-drift agents, anti-foams, and combinations thereof.

5. The process of claim 1 wherein the anionic derivative of alkylpolyglycosides is selected from the group consisting of: anionic carboxylic esters of alkyl polyglycosides, anionic carboxylic esters of alkyl polyglycoside ether carboxylates, anionic carboxylic esters of alkyl polyglycoside phosphates, anionic carboxylic esters of alkyl polyglycoside sulfates, anionic carboxylic esters of alkyl polyglycoside sulfosuccinates, anionic carboxylic esters of alkyl polyglycoside betaines; anionic carboxylic esters of alkyl polyglycoside sulfonates and combinations thereof.

6. The process of claim 1 wherein the anionic derivative of alkylpolyglycosides is an anionic carboxylic ester of an alkyl polyglycoside represented by the formula (I):
If [R—O-(G)ₓ]ₙ-(D)_{y} (I)
wherein:
R is an aliphatic group, saturated or unsaturated, linear or branched, having from 6 to 20, preferably from 8 to 16, atoms of carbon;
G is a residue of a reducing saccharide, and preferably a glucose residue, connected to R—O by means of an ether O-glycosidical bond;
O is an oxygen atom;
D is an acyl residue of a polycarboxylic acid, in acid or salt form;
n is a number between 1 and m−1, where m is the number of carboxylic groups in the acid that originates D;
x is a number from 1 to 10, representing the average degree of oligomerization of G; and
y is a number from 1 to 10 representing the degree of average esterification of (O)ₓ.

7. The process of claim 6, wherein D is an acyl residue of sulfosuccinic acid or of a carboxylic acid selected from the group consisting of citric acid, tartaric acid, maleic acid, malic acid, and mixtures thereof.

8. The process of claim 7, wherein D is an acyl residue of sulfosuccinic, citric or tartaric acid in their sodium salt form.

9. The process of claim 1 wherein the soil is a water repellent soil.

10. A process for wetting a soil comprising applying an aqueous wetting composition comprising:
an anionic derivative of alkyl polyglycosides; and
a compound which is known to function as a wetting agent, to the soil.

11. The process of claim 10 wherein the aqueous wetting composition includes from 400 to 4,000 ppm of the anionic derivative of alkylpolyglycosides and from 400 to 4,000 ppm of the compound which is known to function as a wetting agent.

12. The process of claim 10 wherein the anionic derivative of alkyl polyglycosides is an anionic carboxylic ester of an alkyl polyglycoside represented by the formula (I):
If [R—O-(G)ₓ]ₙ-(D)_{y} (I)
wherein:
R is an aliphatic group, saturated or unsaturated, linear or branched, having from 6 to 20, preferably from 8 to 16, atoms of carbon;
G is a residue of a reducing saccharide, and preferably a glucose residue, connected to R—O by means of an ether O-glycosidical bond;
O is an oxygen atom;
D is an acyl residue of a polycarboxylic acid, in acid or salt form;
n is a number between 1 and m−1, where m is the number of carboxylic groups in the acid that originates D;
x is a number from 1 to 10, representing the average degree of oligomerization of G; and
y is a number from 1 to 10 representing the degree of average esterification of (O)ₓ.

13. The process of claim 10 wherein the compound which is known to function as a wetting agent is selected from the group consisting of: a 4 to 20 moles ethoxylated C₈-C₂₂ fatty alcohol, a 4 to 20 moles ethoxylated and propoxylated C₈-C₂₂ fatty alcohol, a dioctyl sulfosuccinate sodium salt, an ethylene oxide/propylene oxide block copolymer with mass average molecular weight from about 1,000 to about 3,000 and combinations thereof.

14. The process of claim 10 wherein that the soil is a water repellent soil.

15. A composition comprising a soil treated using the method of claim 1.
